(19) United States
(12) Patent Application Publication
(10) Pub. No.: US 2024/0341281 A1
(43) Pub. Date: Oct. 17, 2024

(54) Pull Sensitive Dog Harness System and Method

(71) Applicant: Dave Martine, Brandon (CA)

(72) Inventor: Dave Martine, Brandon (CA)

(21) Appl. No.: 18/133,300

(22) Filed: Apr. 11, 2023

(51) Int. Cl. A01K 27/00; A01K 29/00

(52) U.S. Cl. CPC A01K 27/002; A01K 29/005

(57) ABSTRACT

A pull sensitive harness system is disclosed herein. The pull sensitive harness system includes a harness, a plurality of vibration pads, a leash coupler, a controller, and in some embodiments, a software application. The pull sensitive dog harness system is designed to reduce or eliminate a dog pulling while on a leash, utilizing a quick negative response to its pulling behavior. Particularly, in response to the pulling action from the dog, the pull sensitive dog harness system applies uncomfortable (but not harmful) vibrations to the shoulders and chest of the dog. Once the dog stops pulling, the uncomfortable vibrations stop. Accordingly, the dog learns to stop pulling on the leash.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of dog walking accessories of existing art and more specifically relates to a system and method for preventing a dog from pulling during a walk.

### RELATED ART

Dogs are natural explorers and love to investigate their surroundings, often leading them to pull on their leash when taken for a walk. This pulling is a common problem for dog owners, as it can be uncomfortable and sometimes dangerous if the dog manages to break free. Dogs usually pull on their leash due to excitement or frustration, especially when they are not adequately trained to walk on a leash. Some dogs may also pull to reach a specific location or object, such as a park or another animal. To prevent pulling, it is essential to train dogs to walk on a leash properly.

Historically, shock collars have been provided to train dogs out of unwanted behavior. Shock collars are devices that are placed around a dog's neck and deliver an electric shock as a form of punishment when the dog engages in the unwanted behavior. However, shock collars are a widely debated and controversial topic. Many argue that they can cause physical and psychological harm to dogs, as the electric shock can be painful and distressing for the dog, and can lead to fear, anxiety, and aggression. Therefore, there is a need for a suitable solution that effectively trains the dog to stop pulling on the leash while ensuring that no physical or psychological harm is inflicted on the dog.

### SUMMARY OF THE INVENTION

In view of the foregoing disadvantages inherent in the known dog walking accessories art, the present disclosure provides a novel pull sensitive dog harness system and method. The general purpose of the present disclosure, which will be described subsequently in greater detail, is to provide a harness system that applies uncomfortable, but not harmful, vibrations to a dog when the dog pulls on a leash during a walk. The uncomfortable vibrations cease once the dog reduces or stops the pulling. As such, the dog is taught to stop pulling on the leash.

A pull sensitive harness system for a dog is disclosed herein. The pull sensitive harness system may include a harness, a plurality of vibration pads, a leash coupler, a controller and in some embodiments, a software application for use on a computing device. The harness may be configured for wear around at least a chest and shoulders of the dog. The plurality of vibration pads may be installed in the harness and placed in contact with the dog when the harness is worn by the dog. The plurality of vibration pads may be configured to selectively vibrate (upon actuation). The leash coupler may be attached to the harness and configured to attach a leash to the harness.

The leash coupler may include at least one pull sensor configured to sense a pulling force on the leash (from the dog). The controller may be in communication with the at least one pull sensor and the plurality of vibration pads and configured to: receive, from a user, a selection of a pulling force intensity limit; receive, from the user, a selection of a selected vibration intensity; determine that the pulling force intensity limit has been met at the at least one pull sensor; and cause the plurality of vibration pads to vibrate at the selected vibration intensity, thereby applying uncomfortable vibrations to the dog when pulling on the leash.

According to another embodiment, a method of preventing a dog from pulling whilst being walked on a leash is also disclosed herein. The method may include the steps of: providing the pull sensitive harness system as above, the controller storing the pulling force intensity limit and the selected vibration intensity, and the harness being worn by the dog such that the plurality of vibration pads are in contact with the dog during the walk; sensing, via the at least one pull sensor, a pulling force on the leash exerted by the dog; determining, via the controller, that the pulling force intensity limit has been met; and causing, via the controller, the plurality of vibration pads to vibrate at the selected vibration intensity, thereby applying uncomfortable vibrations to the dog when pulling on the leash.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a pull sensitive dog harness system and method, constructed and operative according to the teachings of the present disclosure.

FIG. 1 is a side perspective view of a pull sensitive dog harness system being used during a walk, according to an embodiment of the disclosure.

FIG. 2 is a front perspective view of the pull sensitive dog harness system illustrating a leash, a leash coupler, and a harness with a plurality of vibration pads installed therein, according to an embodiment of the present disclosure.

FIG. 3 is a front perspective view of the leash coupler including a user interface having a display screen and buttons, according to an embodiment of the present disclosure.

FIG. 4 is a schematic diagram of the pull sensitive dog harness system illustrating the leash coupler including a battery, the user interface, a controller, a pull sensor; and the plurality of vibration pads connected to a second battery, according to an embodiment of the present disclosure.

FIG. 5 is a schematic diagram of the pull sensitive dog harness system illustrating the leash coupler including a receiver in communication with a software application, according to an embodiment of the present disclosure.

FIG. 6 is an example display screen of the software application for selecting a pulling force intensity limit and a selected vibration intensity, according to an embodiment of the present disclosure.

FIG. 7 is an example display screen of the software application for selecting the pulling force intensity limit and the selected vibration intensity, according to an embodiment of the present disclosure.

FIG. 8 is a flow diagram illustrating a method of preventing a dog from pulling whilst being walked on a leash, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to dog walking accessories and more particularly to a pull sensitive dog harness system and method. Generally, the pull sensitive dog harness system may include a leash coupler, a harness having vibration pads therein, and in some embodiments, a smartphone application. The pull sensitive dog harness system may be designed to reduce or eliminate a dog pulling while on a leash by providing a quick negative response to its pulling behavior.

Although the dog is not harmed, in response to the pulling force from the dog, the pull sensitive dog harness system may apply uncomfortable vibrations to the shoulders and chest of the dog. Particularly, once the dog begins pulling beyond a pre-set resistance/force limit, a signal may be sent from the leash coupler to the vibration pads to apply the uncomfortable vibrations. One the dog stops or reduces their pulling, a signal may again be sent to the vibration pads to stop the uncomfortable vibrations. In some embodiments, pull sensitivity and vibration intensity may be set directly from the leash coupler. In other embodiments, the pull sensitivity and the vibration intensity may be set via the smartphone application, and the leash coupler may include a Bluetooth receiver for receiving communication from Bluetooth receiver.

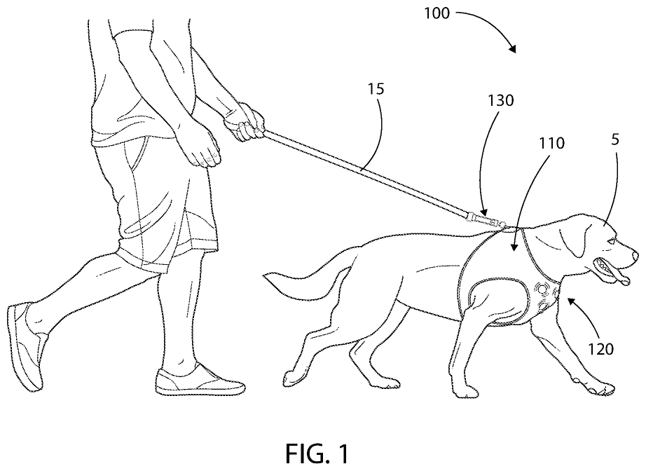

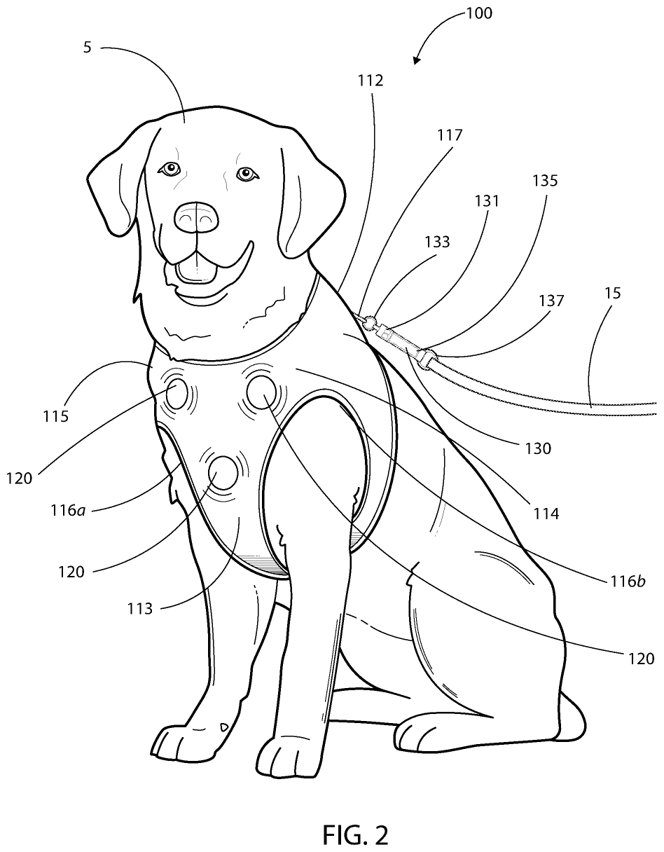

Referring now more specifically to the drawings by numerals of reference, there is shown in FIGS. 1-7, various views of a pull sensitive harness system 100. As discussed above and as shown in FIGS. 1-2, the pull sensitive harness system 100 may be particularly used with a dog 5 to prevent the dog 5 from pulling on a leash 15 during a walk. As shown in FIGS. 1-7, the pull sensitive harness system 100 may include a harness 110, a plurality of vibration pads 120, a leash coupler 130, a controller 140, and in some embodiments, a software application 150. The software application 150 may be for use on a computing device 10, such as a smartphone.

Referring more specifically to FIGS. 1-3, there is shown the harness 110, the plurality of vibration pads 120 and the leash coupler 130. As shown in FIGS. 1-2, the harness 110 may be configured for wear around at least a chest and shoulders of the dog 5. As such, the harness 110 may include a back portion 112 in contact with a back of the dog 5 when worn, a chest portion 113 in contact with a chest of the dog 5 when worn, a front left shoulder portion 114 connecting the chest portion 113 to the back portion 112 at a left side of the harness 110 and in contact with a front left shoulder of the dog 5 when worn, a front right shoulder portion 115 connecting the chest portion 113 to the back portion 112 at a right side of the harness 110 and in contact with a front right shoulder of the dog 5 when worn, and a pair of front leg openings 116a, 116b each underneath one of the shoulder portions 114, 115 and each for receiving a front leg of the dog 5 when worn. It should however be appreciated that the harness 110 may not be limited to this particular configuration.

The plurality of vibration pads 120 may be installed in the harness 110 and placed in contact with the dog 5 when the harness 110 is worn by the dog 5. The plurality of vibration pads 120 may be configured to selectively vibrate (vibration is shown via arcuate lines in FIG. 1 and FIG. 2). In some embodiments, the plurality of vibration pads 120 may run in a series of alternating vibrations. The plurality of vibration pads 120 may be installed in the harness 110 at various strategic places to enable the vibrations applied by the plurality of vibration pads 120 to be felt by the dog 5 as an uncomfortable sensation. For example, as shown particularly in FIG. 2, one of the plurality of vibration pads 120 may be located at the front left shoulder portion 114 of the harness 110 and another of the plurality of vibration pads 120 may be located at the front right shoulder portion 115 of the harness 110.

In some embodiments, in addition to this (or instead of this), one of the plurality of vibration pads 120 may be located at a mid of the chest portion 113 of the harness 110, the mid chest portion 113 in contact with a mid-chest of the dog when the harness 110 is worn. In total, the plurality of vibration pads 120 may include (but are not limited to) between 2-4 vibration pads 120. It should be appreciated that the plurality of vibration pads 120 are not limited to this amount, nor are they limited to these particular positions on the harness 110.

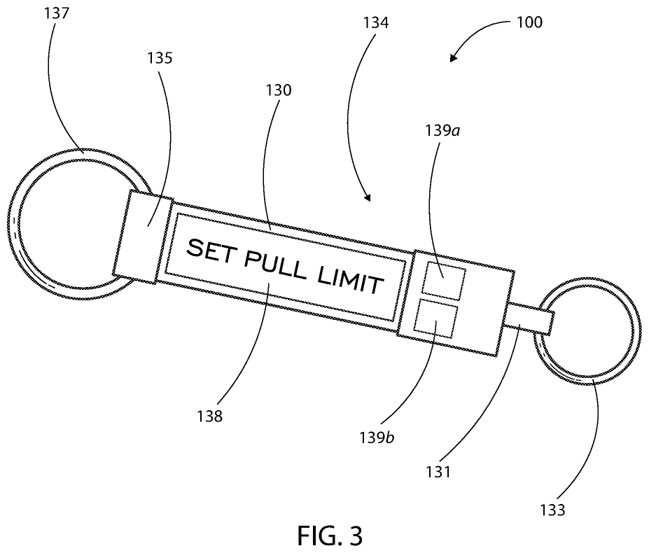

As shown in FIGS. 1-2, the leash coupler 130 may be attached to the harness 110 and configured to attach a leash 15 to the harness 110. For example, as shown in FIGS. 2-3, the leash coupler 130 may include a first end 131 having a first coupler 133, such as a ring, thereon, and a second end 135 (opposite the first end 131) and having a second coupler 137, again such as a ring, thereon. The first coupler 133 may attach to an attachment 117 on the harness 110 (such as a loop) and the second coupler 137 may attach to the leash 15.

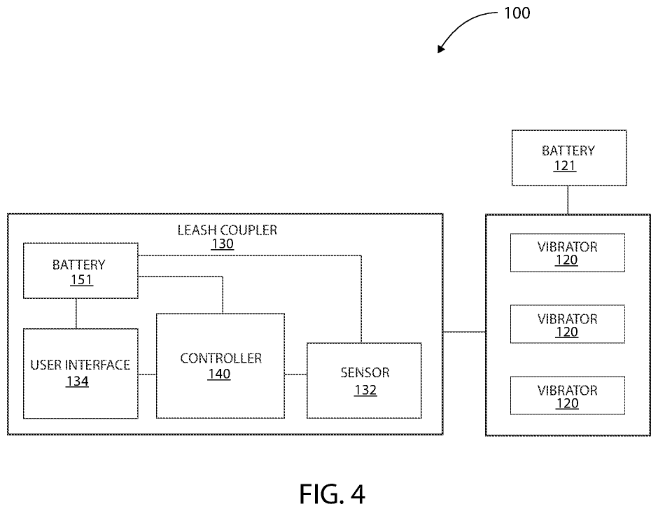

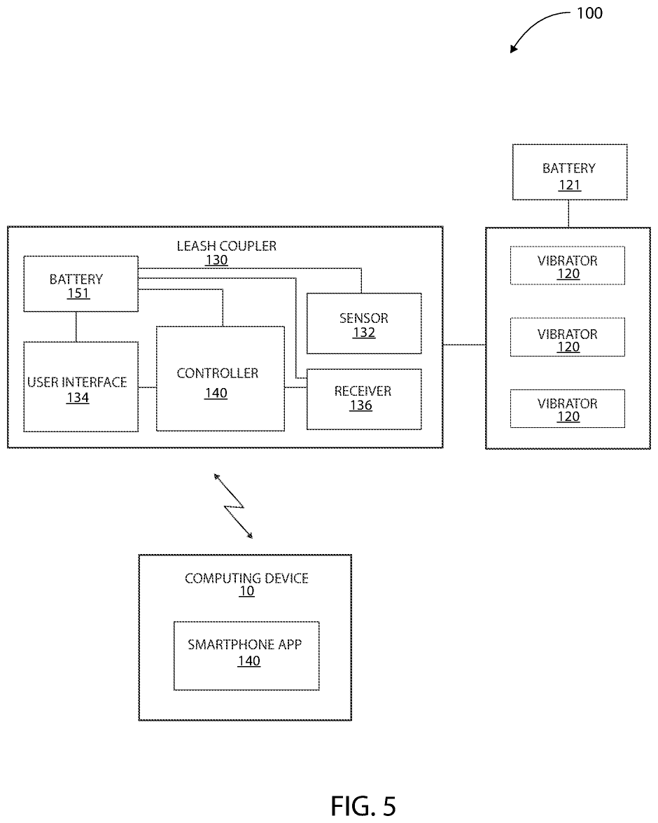

Referring more specifically now to FIGS. 3-7, there is shown the leash coupler 130, the controller 140 and the software application 150, according to some embodiments of the present disclosure. As shown in FIGS. 3-5, the leash coupler 130 may include a user interface 134. In some embodiments, as shown in FIG. 3, the user interface 134 may include (but is not limited to) a display screen 138 and one or more buttons 139a, 139b. Further, as shown in FIGS. 4-5, the leash coupler 130 may additionally include at least one pull sensor 132 and a receiver 136. The receiver 136 may be configured to receive communication from the software application 150. In some embodiments, the receiver 136 may include, but is not limited to, a Bluetooth receiver.

Further, as shown in FIGS. 4-5, the leash coupler 130 may include a battery 151, for providing power to the user interface 134, the controller 140, the at least one pull sensor 132 and in some embodiments the receiver 136. In addition, in some embodiments a second battery 121 may be provided for providing power to the plurality of vibration pads 120.

The at least one pull sensor 132 may be configured to sense a pulling force on the leash 15, exerted by the dog 5. The at least one pull sensor 132 may be positioned on the leash coupler 130 so as to solely sense pulling forces from the dog 5, to prevent inadvertent sensing of a pulling force exerted by an owner walking the dog 5. In some examples, the at least one pull sensor 132 may utilize one or more force or tension sensors, to measure the amount of force applied thereto. However, it should be appreciated that the at least one pull sensor 132 is not limited to a force sensor. It is contemplated that the at least one pull sensor 132 be of a range and sensitivity appropriate for the pulling force of the dog 5. In some examples, the at least one pull sensor 132 may be calibrated to measure pulling force in pound-force units.

As shown in FIGS. 4-5, the controller 140 may be in communication with the at least one pull sensor 132, the plurality of vibration pads 120, and in some embodiments, the software application 150. In some embodiments, as shown, the controller 140 may be integral to the leash coupler 130. The communication may be a wired communication or a wireless communication.

In some examples, the controller 140 may include a microprocessor and a memory. The memory may store instructions that cause the controller 140 (microprocessor) to perform a specific set of commands when executed. For example, the controller 140 may be configured to: receive, from a user, a selection of a pulling force intensity limit; receive, from the user, a selection of a selected vibration intensity; determine that the pulling force intensity limit has been met at the at least one pull sensor 132; and cause the plurality of vibration pads 120 to vibrate at the selected vibration intensity, thereby applying uncomfortable vibrations to the dog 5 when pulling on the leash 15.

Further, in some embodiments, the controller 140 may: determine that the pulling force on the leash 15 has decreased below the pulling force intensity limit; and cause the plurality of vibration pads 120 to cease vibrating, thereby stopping the application of uncomfortable vibrations to the dog 5. As such, the dog 5 eventually learns that if they pull on the leash 15, uncomfortable vibrations begin; and if they stop pulling on the leash 15, the uncomfortable vibrations stop. Thereby, the dog 5 learns to stop pulling on the leash 15. In some embodiments, to determine that the pulling force intensity limit has been met or the pulling force has decreased, the controller 140 may continuously receive data from the at least one pull sensor 132 regarding a ‘pull status’ and once the pulling force intensity limit is met or the pulling force has decreased, the controller 140 recognizes this and acts accordingly.

The pulling force intensity limit may be the limit at which the dog 5 is able to pull (or exert force) on the leash 15 before the uncomfortable vibrations begin. The particular amount of force may differ depending on breed of dog, size of dog, strength of dog, etc. For example, a large dog (weighing between 50-100 lb or more) may pull on a leash with a force ranging between 50-100 lb, whereas a small dog (weighing between 10-20 lb) may pull considerably less than that. As such, if the pulling force intensity limit was set at 100 lb and the pull sensitive harness system 100 was used by a small dog, the small dog may pull on the leash 15 with a force lower than 100 lb, and thus the controller 140 would not be trigger the uncomfortable vibrations and the dog 5 would not learn. Due to this, the pulling force intensity limit may be adjustable and selected by the user.

The selected vibration intensity may be the intensity at which the vibrations need to be applied to the dog 5 for them to be felt at an uncomfortable enough intensity for the dog 5 to want them to stop, but not painful or harmful to the dog 5. Again, the selected vibration intensity may vary from dog to dog, based on breed of dog, size of dog, strength of dog, etc. and also based on weight, body fat, hair thickness, etc. For example, the plurality of vibration pads 120 may each be configured to apply between 20-50 Hertz (Hz). As such, the user may select an intensity between 20-50 Hz, with 20 being low, and 50 being high. It should be appreciated that these units are given as examples to aid in understanding of the present disclosure and are not meant to limit the invention in any way.

The pulling force intensity limit and the selected vibration intensity may be selected either via the user interface 134 on the leash coupler 130, via the software application 150, or both. For example, in some embodiments, only the leash coupler 130 may be used. In other examples, the user may select the least one pulling force intensity limit and the selected vibration intensity via the leash coupler 130 on one occasion; and via the software application 150 on another occasion. When selected via the software application 150, the software application 150 may send the data (the pulling force intensity limit and the selected vibration intensity) to the controller 140, which may be received at the receiver 136 in the leash coupler 130. Particularly, the software application 150 may send the data via Bluetooth, and the controller 140 may receive the data via the Bluetooth receiver 136.

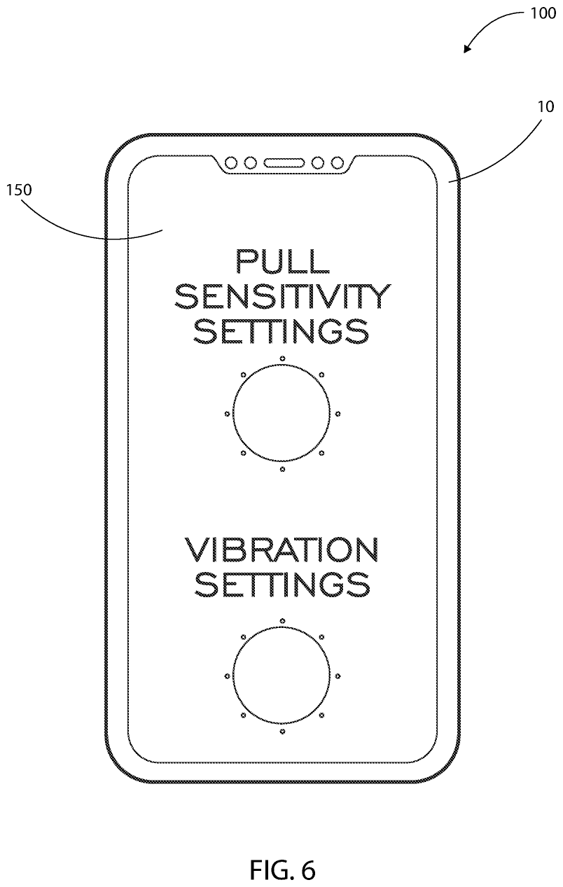

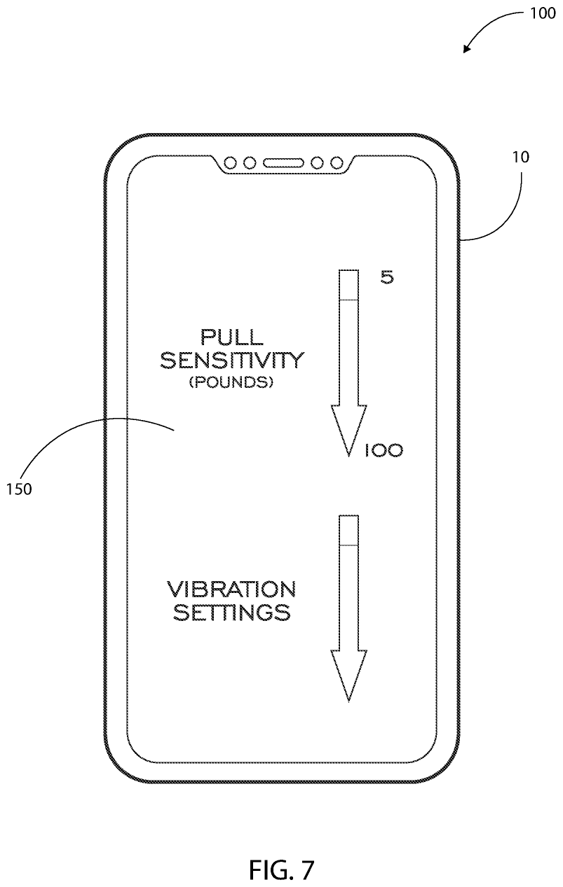

FIGS. 6-7 demonstrate example screens of the software application 150 when selecting and/or adjusting the pulling force intensity limit and the selected vibration intensity. In one example, as shown in FIG. 6, the pulling force intensity limit and the selected vibration intensity may each be set or selected via a ‘dial’. In another example, as shown in FIG. 7, the pulling force intensity limit and the selected vibration intensity may be set by selecting a position on an arrow. In this example, the pulling force intensity limit is measured in pounds from a range of between 5 lb-100 lb. Accordingly, if the user selects ‘5’, during the walk, if the dog begins to pull on the leash 15 with a force that equals 5 lb or more, the controller 140 then determines that the pulling force intensity limit has been met and causes the plurality of vibration pads 120 to vibrate.

It should be appreciated that it may not be necessary to select the pulling force intensity limit and the selected vibration intensity before each walk. The memory on the leash coupler 130, or memory on the computing device 10 may store the selections.

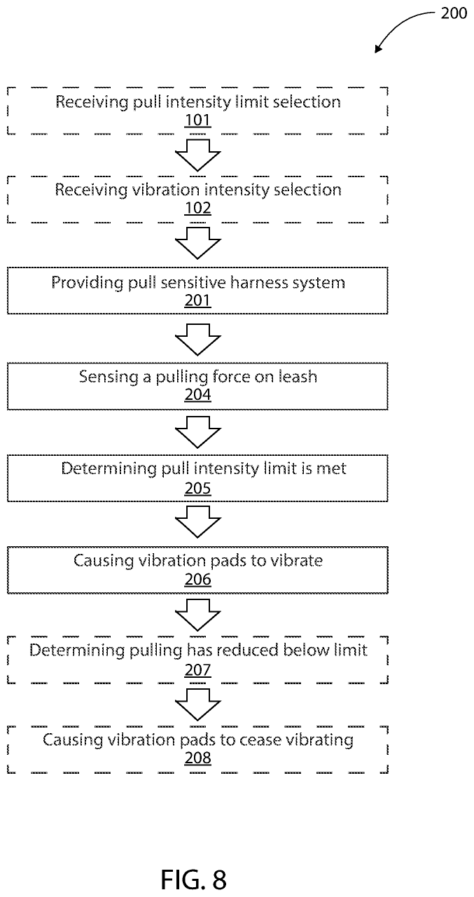

Referring now to FIG. 8 showing a flow diagram illustrating a method of preventing a dog from pulling whilst being walked on a leash (“method 200”), according to an embodiment of the present disclosure. In particular, the method 200 may include one or more components or features of the pull sensitive harness system 100 as described above. As illustrated, the method 200 may include the steps of: step one 201, providing the pull sensitive harness system, the controller storing the pull force intensity limit and the selected vibration intensity (in the memory), the harness being worn by the dog such that the plurality of vibration pads are in contact with the dog during the walk; step two 202, sensing, via the at least one pull sensor, a pulling force on the leash exerted by the dog; step three 203, determining, via the controller, that the pulling force intensity limit has been met; and step four 204, causing, via the controller, the plurality of vibration pads to vibrate at the selected vibration intensity, thereby applying uncomfortable vibrations to the dog.

Further steps may include: step five 205, determining, via the controller, that the pulling force on the leash has decreased below the pulling force intensity limit; and step six 206, causing, via the controller, the plurality of vibration pads to cease vibrating, thereby stopping the application of uncomfortable vibrations to the dog. Further steps may include step 101, receiving, at the controller, a selection of the pulling force intensity limit from a user; and step 102, receiving, at the controller, a selection of the selected vibration intensity selection from the user. In addition, the steps of receiving the selection of the pulling force intensity limit and receiving the selection of the selected vibration intensity (101, 102) includes receiving the selections either via user input through the user interface or user input through the software application, or both.

It should be noted that certain steps are optional and may not be implemented in all cases. Optional steps of the method 200 are illustrated using dotted lines in FIG. 8 so as to distinguish them from the other steps of the method 200. It should also be noted that the steps described in the method 200 can be carried out in many different orders according to user preference. The use of “step of” should not be interpreted as “step for”, in the claims herein and is not intended to invoke the provisions of 35 U.S.C. § 112 (f). It should also be noted that, under appropriate circumstances, considering such issues as design preference, user preferences, marketing preferences, cost, structural requirements, available materials, technological advances, etc., other methods for preventing pulling from a dog being walked on a leash are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A pull sensitive harness system for a dog, the pull sensitive harness system comprising:
a harness for wear around at least a chest and shoulders of the dog;
a plurality of vibration pads installed in the harness and placed in contact with the dog when the harness is worn by the dog, the plurality of vibration pads configured to selectively vibrate;
a leash coupler attached to the harness and configured to attach a leash to the harness, the leash coupler including at least one pull sensor configured to sense a pulling force on the leash exerted by the dog; and
a controller in communication with the at least one pull sensor and the plurality of vibration pads, the controller configured to:
receive, from a user, a selection of a pulling force intensity limit;
receive, from the user, a selection of a selected vibration intensity;
determine that the pulling force intensity limit has been met at the at least one pull sensor; and
cause the plurality of vibration pads to vibrate at the selected vibration intensity, thereby applying uncomfortable vibrations to the dog when pulling on the leash.

2. The pull sensitive harness system of claim 1, wherein the controller is further configured to:
determine that the pulling force on the leash has decreased below the pulling force intensity limit; and
cause the plurality of vibration pads to cease vibrating, thereby stopping the application of uncomfortable vibrations to the dog.

3. The pull sensitive harness system of claim 2, wherein the leash coupler further comprises a user interface.

4. The pull sensitive harness system of claim 3, wherein the controller receives the pulling force intensity limit and the selected vibration intensity limit via user input through the user interface.

5. The pull sensitive harness system of claim 4, wherein the controller is integral to the leash coupler.

6. The pull sensitive harness system of claim 1, further comprising a software application for use on a computing device.

7. The pull sensitive harness system of claim 6, wherein the leash coupler further comprises a receiver for receiving communication from the software application.

8. The pull sensitive harness system of claim 7, wherein the receiver includes a Bluetooth receiver.

9. The pull sensitive harness system of claim 8, wherein the controller receives the pulling force intensity limit and the vibration intensity limit via user input through the software application.

10. The pull sensitive harness system of claim 9, wherein the plurality of vibration pads includes between 2-4 vibration pads.

11. The pull sensitive harness system of claim 10, wherein one of the plurality of vibration pads is located at a front left shoulder portion of the harness, the front left shoulder portion in contact with a front left shoulder of the dog when the harness is worn, and wherein another one of the plurality of vibration pads is located at a front right shoulder portion of the harness, the front left shoulder portion in contact with a front right shoulder of the dog when the harness is worn.

12. The pull sensitive harness system of claim 11, wherein one of the plurality of vibration pads is located at a mid of a chest portion of the harness, the mid chest portion in contact with a mid of a chest of the dog when the harness is worn.

13. A pull sensitive harness system for a dog, the pull sensitive harness system comprising:
a harness for wear around at least a chest and shoulders of the dog;
a plurality of vibration pads installed in the harness and placed in contact with the dog when the harness is worn by the dog, the plurality of vibration pads configured to selectively vibrate;
a software application for use on a computing device;
a leash coupler attached to the harness and configured to attach a leash to the harness, the leash coupler including at least one pull sensor configured to sense a pulling force on the leash exerted by the dog, a receiver configured to receive communication from the software application, a user interface, and a controller in communication with the at least one pull sensor, the plurality of vibration pads, and the software application, the controller configured to:
receive, from a user, a selection of a pulling force intensity limit via at least one of the software application and the user interface on the leash coupler;
receive, from the user, a selection of a selected vibration intensity via at least one of the software application and the user interface on the leash coupler;
determine that the pulling force intensity limit has been met at the at least one pull sensor;
cause the plurality of vibration pads to vibrate at the selected vibration intensity, thereby applying uncomfortable vibrations to the dog when pulling on the leash;
determine that the pulling force on the leash has decreased below the pulling force intensity limit; and
cause the plurality of vibration pads to cease vibrating, thereby stopping the application of uncomfortable vibrations to the dog when pulling on the leash.

14. The pull sensitive harness system of claim 13, wherein the receiver includes a Bluetooth receiver.

15. The pull sensitive harness system of claim 14, wherein the plurality of vibration pads includes between 2-4 vibration pads, wherein one of the plurality of vibration pads is located at a front left shoulder portion of the harness, the front left shoulder portion in contact with a front left shoulder of the dog when the harness is worn, wherein another one of the plurality of vibration pads is located at a front right shoulder portion of the harness, the front left shoulder portion in contact with a front right shoulder of the dog when the harness is worn, and wherein one of the plurality of vibration pads is located at a mid of a chest portion of the harness, the mid of the chest portion in contact with a mid of a chest of the dog when the harness is worn.

16. A method of preventing a dog from pulling whilst being walked on a leash, the method comprising the steps of:
providing a pull sensitive harness system comprising a harness, a plurality of vibration pads installed in the harness, a leash coupler attached to the harness and attaching the leash to the harness, and a controller, the leash coupler including at least one pull sensor, the controller storing a pulling force intensity limit and a selected vibration intensity, the harness being worn by the dog such that the plurality of vibration pads are in contact with the dog during the walk;
sensing, via the at least one pull sensor, a pulling force on the leash exerted by the dog;
determining, via the controller, that the pulling force intensity limit has been met; and
causing, via the controller, the plurality of vibration pads to vibrate at the selected vibration intensity, thereby applying uncomfortable vibrations to the dog.

17. The method of claim 16, the method further comprising the steps of:
determining, via the controller, that the pulling force on the leash has decreased below the pulling force intensity limit; and
causing, via the controller, the plurality of vibration pads to cease vibrating, thereby stopping the application of uncomfortable vibrations to the dog.

18. The method of claim 17, the method further comprising the steps of:
receiving, at the controller, a selection of the pulling force intensity limit from a user;
receiving, at the controller, a selection of the selected vibration intensity from the user.

19. The method of claim 18, wherein the leash coupler further comprises a user interface;
wherein the step of receiving the selection of the pulling force intensity limit includes receiving the selection of the pulling force intensity limit via user input through the user interface; and
wherein the step of receiving selection of the selected vibration intensity includes receiving selection of the selected vibration intensity via user input through the user interface.

20. The method of claim 19, wherein the pull sensitive harness system for a dog further comprises a software application;
wherein the step of receiving the selection of the pulling force intensity limit includes receiving the selection of the pulling force intensity limit via user input through the software application; and
wherein the step of receiving selection of the selected vibration intensity includes receiving selection of the selected vibration intensity via user input through the software application.
